(19) United States
(12) Patent Application Publication
(10) Pub. No.: US 2014/0254503 A1
(43) Pub. Date: Sep. 11, 2014

(54) SIGNAL DETECTOR FOR UPLINK CONTROL CHANNEL AND TIME ERROR CORRECTION METHOD THEREOF

(71) Applicant: Electronics and Telecommunications Research Institute, Daejeon-si (KR)

(72) Inventors: Hyeong-Sook PARK, Daejeon-si (KR); Jun-Woo Kim, Daejeon-si (KR); Youn-Ok Park, Daejeon-si (KR)

(73) Assignee: Electronics and Telecommunications Research Institute, Daejeon-si (KR)

(21) Appl. No.: 13/966,353

(22) Filed: Aug. 14, 2013

(30) Foreign Application Priority Data
Mar. 6, 2013 (KR) 10-2013-0024179

(51) Int. Cl. H04W 72/04

(52) U.S. Cl. CPC H04W 72/0413
USPC 370/329

(57) ABSTRACT

Provided are a signal detector for an uplink control channel and a time error correction method capable of simply correcting time errors, which occur during adjustment of a starting point of an FFT of an uplink control channel signal, by use of differential demodulation and thus improving the signal detection performance of an uplink control channel.

### CROSS-REFERENCE TO RELATED APPLICATION

This application claims the benefit under 35 U.S.C. §119(a) of a Korean Patent Application No. 10-2013-0024179, filed on Mar. 6, 2013, in the Korean Intellectual Property Office, the entire disclosure of which is incorporated herein by reference for all purposes.

### BACKGROUND

1. Field

The following description relates to a technology for signal detection for an uplink control channel, and more particularly, to a signal detector for an uplink control channel and a time error correction method thereof.

2. Description of the Related Art

A technology for transmitting a control signal through a control channel in a wireless communication system has been suggested in Korean Patent Publication No. 10-2010-0040653 (Published on Apr. 20, 2010), and the like. In order to support various schemes in an orthogonal frequency division multiplexing (OFDM) access system, for example, in order to support a spatial multiplexing scheme between a user terminal and a base station, control signal transmission between a user terminal and a base station is required.

The control signal includes a feedback channel in which a user terminal reports a channel state to a base station, an ACK/NACK signal serving as a response to data transmission, and a bandwidth request signal requesting allocation of wireless resources. Such a control signal is assigned a different sequence depending on each user terminal and transmitted, and in order to detect a signal transmitted from the user terminal, the base station takes as many correlations as the number of possible sequences and detects a code having the maximum as the signal transmitted from the user terminal.

In this case, for an uplink reception signal, time synchronization is performed by use of a ranging signal, but time errors exist at all times in a process of adjusting a fast Fourier transform (FFT) starting point such that the FFT starting point is allocated within a cyclic prefix (CP). In general, the length of a sequence of an uplink control channel is short, so these errors exert a great influence on the performance.

In this regard, the inventor of the present disclosure has studied techniques capable of improving signal detection performance of an uplink control channel in a simple manner by using a differential demodulation scheme composed of a phase shifter and a multiplier.

### SUMMARY

The following description relates to a signal detector for an uplink control channel and a time error correction method thereof, capable of improving the signal detection performance of an uplink control channel by simply correcting time errors, which occur during adjustment of an FFT starting point of an uplink control channel signal, by use of differential modulation.

In one general aspect, a signal detector for an uplink control channel, the signal detector comprising: a first multiplier configured to multiply a signal subjected to a fast Fourier transform (FFT) by a possible number of sequences; a phase shifter configured to shift a phase of a signal output from the first multiplier; a second multiplier configured to multiply a signal, which is directly output from the first multiplier and not phase-shifted, by a conjugate signal of the signal whose phase was shifted by the phase shifter; and an integrator configured to integrate a signal being output from the second multiplier to remove a phase component of a subcarrier of the signal.

The signal detector may further include a normalizer configured to normalize the signal of the subcarrier, the phase component of which is removed, output from the integrator.

The signal detector may further include a signal selector configured to select a signal having a maximum value among normalized signals output from the normalizer.

The signal detector may further include a sequence generator configured to generate a possible number of sequences.

The signal detector may further include an FFT unit configured to convert a received uplink control channel time domain signal into a frequency domain signal.

The signal detector may further include a guard interval remover configured to remove a guard interval from the received uplink control channel time domain signal.

The signal detector may further include an RF processor configured to receive an uplink control channel time domain signal transmitted from a user terminal.

In another general aspect, a time error correction method of a signal detector for an uplink control channel, the time error correction method including first multiplying a signal subjected to a fast Fourier transform (FFT) by a possible number of sequences; shifting a phase of the signal multiplied in the first multiplying; second multiplying the signal, which is multiplied in the first multiplying operation but not phase-shifted, by a conjugate signal of the signal whose phase is shifted in the shifting; and integrating the signal multiplied in the second multiplying to remove a phase component of a subcarrier of the signal.

The time error correction method may further include normalizing the signal of which the subcarrier has the phase component removed in the integrating.

The time error correction method may further include selecting a signal having a maximum value among signals obtained from the normalizing.

The time error correction method may further include generating a possible number of sequences.

The time error correction method may further include receiving an uplink control channel time domain signal transmitted from a user terminal; removing a guard interval from the received uplink control channel time domain signal; and converting the uplink control channel time domain signal, the guard interval of which is removed, into a frequency domain signal.

As is apparent from the above description, time errors, which occur during adjustment of a starting point of an FFT of an uplink control channel signal, are simply corrected by use of differential modulation, thereby improving the signal detection performance of an uplink control channel, and preventing the performance degradation.

Other features and aspects will be apparent from the following detailed description, the drawings, and the claims.

### BRIEF DESCRIPTION OF THE DRAWINGS

FIG. 1 is a block diagram illustrating a signal detector for an uplink control channel in accordance with an embodiment of the present disclosure.

FIG. 2 is a flowchart showing a time error correction method of a signal detector for an uplink control channel in accordance with an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. In addition, terms described below are terms defined in consideration of functions in the present invention and may be changed according to the intention of a user or an operator or conventional practice. Therefore, the definitions must be based on content throughout this disclosure.

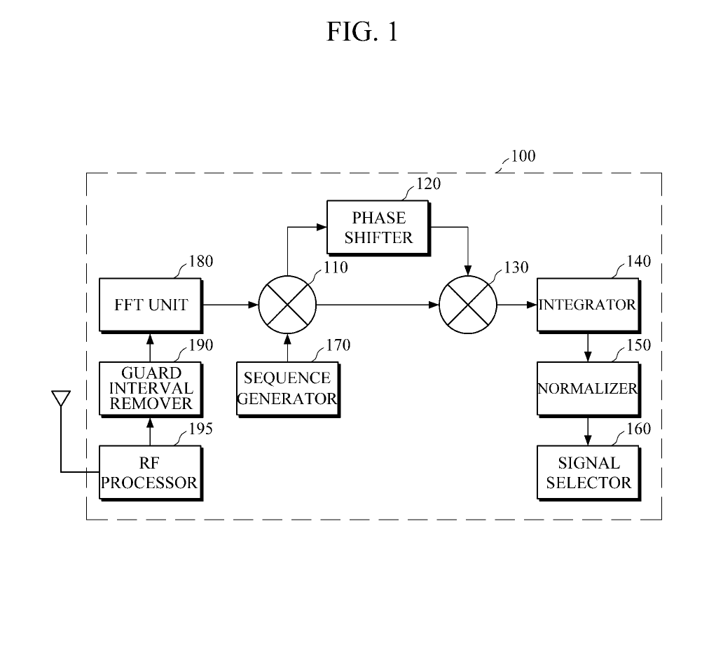

FIG. 1 is a block diagram illustrating a signal detector for an uplink control channel in accordance with an embodiment of the present disclosure. Referring to FIG. 1, a signal detector 100 for an uplink control channel includes a first multiplier 110, a phase shifter 120, a second multiplier 130 and an integrator 140.

The first multiplier 110 multiples a signal, which has been subjected to a fast Fourier transform (FFT), by a possible number of sequences. A different sequence depending on a user terminal is allocated to a control signal, which is a time domain signal, being transmitted through an uplink control channel from a user terminal (not shown) of an orthogonal frequency division multiplexing (OFDM) access system, and the control signal is transmitted.

A base station having received the uplink control channel time domain signal removes a guard interval from the uplink control channel time domain signal, performs an FFT on the time domain signal, the guard interval of which is removed to convert the time domain signal into a frequency domain signal, and then detects the control signal. The guard interval is a signal inserted into each OFDM signal, and represents a marginal space inserted to prepare for a case in which a receiving end fails to achieve precise synchronization.

For example, time synchronization between a base station and a user terminal is achieved by use of a control signal being transmitted through a ranging channel. In this case, in order for a starting point of an FFT to be allocated within a cyclic prefix (CP), the starting point of the FFT is adjusted. However, in this process, time errors exist at all times.

In order to correct such a time error, the following process is performed. First, a signal subjected to an FFT through the first multiplier 110 is multiplied by a possible number of sequences.

The signal subjected to the FFT is expressed as equation 1 below. In equation 1, Y is a signal subjected to an FFT, u is the number of user terminals, j is a receiving antenna, k is an index of a subcarrier, X is a transmitted signal, Z is additive white Gaussian noise (AWGN) having an average of 0 and a standard variation of 62, and H is a channel response.

$${Y}_{j} ( k ) = {\sum }_{u = 1}^{{N}_{u}} {H}_{j}^{u} ( k ) {X}_{j}^{u} ( k ) + {Z}_{j}^{u} ( k ) \qquad [ Equation 1 ]$$

A signal being output from the first multiplier 110 is expressed as equation 2. In equation 2, S is an output signal of the first multiplier, N_{FFT} is the sampling frequency, u is the number of user terminals, j is a receiving antenna, k is an index of a subcarrier ranging from 0 to N_{FFT}−1, X is a transmitted signal, Z′ is AWGN having an average of 0 and a standard variation of σ2, H is a channel response, l is a received time domain signal x(t−τ) sampled with τ=l Ts, and Ts is a sampling time.

Sⱼ(k)=Hⱼ^{u}(k)exp(−j2πkl/N_{FFT})|Xⱼ^{u}(k)|²+Z′ⱼ^{u}(k) [Equation 2]

The phase shifter 120 shifts the signal being output from the first multiplier 110. A time error in a time domain is represented as a phase shift component in a frequency domain. In order to generate a signal capable of removing such a phase component, the signal being output from the first multiplier 110 is phase-shifted through the phase shifter 120.

The second multiplier 130 multiplies a signal, which is directly output from the first multiplier 110 and not phase-shifted, by a conjugate signal of the signal whose phase is shifted by the phase shifter 120. The signal multiplied by the second multiplier 130 is expressed as equation 3 below. Equation 3 represents a multiplication of a phase-shifted k−1^{th} signal and a k^{th} signal that is not phase-shifted.

Sⱼ(k−1)*Sⱼ(k) [Equation 3]

The integrator 140 integrates a signal being output from the second multiplier 130 to remove a phase component of a subcarrier. The integrated signal is expressed as equation 4 below.

$$\vert {\sum }_{k = 0}^{N - 1} {S}_{j} ( k - 1 ) * {S}_{j} ( k ) \vert \qquad [ Equation 4 ]$$

A time error in the time domain is represented as a phase shift component in the frequency domain. As shown in equation 5 below, when it is assumed that channel characteristics of two adjacent subcarriers are identical to each other, the phase component may be removed as in equation 6.

Hⱼ^{u}(k)/≈Hⱼ^{u}(k−1) [Equation 5]

exp(−j2πkl/N_{FFT})≈exp(−j2(k−1)l/N_{FFT}) [Equation 6]

According to the present disclosure, time errors, which occur during adjustment of a starting point of an FFT of an uplink control channel signal, are simply corrected by use of differential demodulation, thereby improving the signal detection performance of an uplink control channel, and preventing the performance degradation.

Meanwhile, in accordance with an additional aspect of the present disclosure, the signal detector 100 for the uplink control channel may further include a normalizer 150. The normalizer 150 normalizes the signal of the subcarrier, the phase component of which is removed, being output from the integrator 140. The normalization by the normalizer 150 is expressed as equation 7, and a signal R finally output from the normalizer 150 is expressed as equation 8.

$$\begin{matrix}{\sum }_{k = 0}^{N - 1} {\vert {S}_{j} ( k ) \vert}^{2} & [ Equation 7 ] \\ {R}_{j} ( k ) = \frac{\vert {\sum }_{k = 0}^{N - 1} {S}_{j} ( k - 1 ) * {S}_{j} ( k ) \vert}{{\sum }_{k = 0}^{N - 1} {\vert {S}_{j} ( k ) \vert}^{2}} & [ Equation 8 ]\end{matrix}$$

Meanwhile, in accordance with an additional aspect of the present disclosure, the signal detector 100 for the uplink control channel may further include a signal selector 160. The signal selector 160 selects a signal having a maximum value among normalized signals being output from the normalizer 150. That is, the signal selector 160 selects a signal having a maximum value among signals output from equation 8, thereby detecting the control signal being transmitted from the user terminal through the uplink control channel.

Meanwhile, in accordance with an additional aspect of the present disclosure, the signal detector 100 for the uplink control channel may further include a sequence generator 170. The sequence generator 170 generates a possible number of sequences. The sequence generated by the sequence generator 170 is multiplied by the signal, which has been subjected to the FFT, by the first multiplier 110.

Meanwhile, in accordance with an additional aspect of the present disclosure, the signal detector 100 for the uplink control channel may further include an FFT unit 180. The FFT unit 180 converts a received uplink control channel time domain signal into a frequency domain signal. The first multiplier 110 multiplies the signal subjected to the FFT by the FFT unit 180 by the sequence generated by the sequence generator 170.

Meanwhile, in accordance with an additional aspect of the present disclosure, the signal detector 100 for the uplink control channel may further include a guard interval remover 190 configured to remove a guard interval from the received uplink control channel time domain signal.

The guard interval is a signal inserted into each OFDM signal, and represents a marginal space inserted to prepare for a case in which a receiving end fails to achieve precise synchronization, and thus the guard interval needs to be removed for phase offset. The guard interval is removed from the uplink control channel time domain signal by the guard interval remover 190.

Meanwhile, in accordance with an additional aspect of the present disclosure, the signal detector 100 for the uplink control channel may further include an RF processor 195. The RF processor 195 may receive an uplink control channel time domain signal transmitted from a user terminal.

If an uplink control channel time domain signal is received by the RF processor 195, a guard interval is removed from the uplink control channel time domain signal, and an FFT is performed on the time domain signal, the guard interval of which is removed, so that a frequency domain signal is generated.

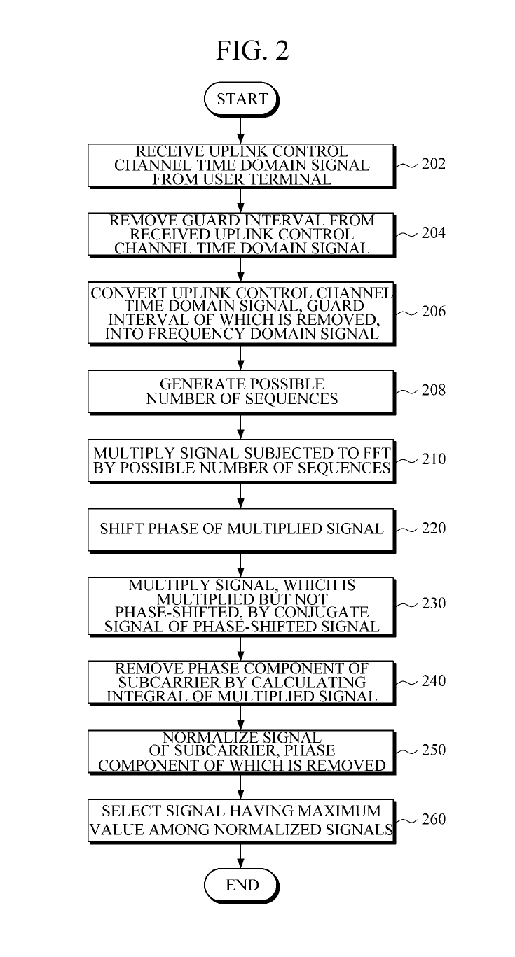

Hereinafter, a time error correction method of the signal detector for the uplink control channel in accordance with an embodiment of the present disclosure will be described with reference to FIG. 2. FIG. 2 is a flowchart showing the time error correction method of the signal detector for the uplink control channel in accordance with an embodiment of the present disclosure.

First, in a first multiplying operation in 210, the signal detector for the uplink control channel multiplies a signal subjected to an FFT by a possible number of sequences. The description of the first multiplying operation is identical to the above description, and thus will be omitted.

Thereafter, in a phase shift operation in 220, the signal detector for the uplink control channel shifts a phase of the signal multiplied in the first multiplying operation in 210. The description of the phase shift operation is identical to the above description, and thus will be omitted.

Thereafter, in a second multiplying operation in 230, the signal detector for the uplink control channel multiplies a signal, which is multiplied in the first multiplying operation in 210 but not phase-shifted, by a conjugate signal of the phase-shifted signal from the phase shift operation in 220. The description of the second multiplying operation is identical to the above description, and thus will be omitted.

Thereafter, in an integrating operation in 240, the signal detector for the uplink control channel integrates a signal multiplied in the second multiplying operation in 230 to remove a phase component of a subcarrier. The description of the integrating operation is identical to the above description, and thus will be omitted.

According to the present disclosure, time errors, which occur during adjustment of a starting point of an FFT of an uplink control channel signal, are simply corrected by use of differential modulation, thereby improving the signal detection performance of an uplink control channel, and preventing the performance degradation.

Meanwhile, in accordance with an additional aspect of the present disclosure, the time error correction method of the signal detector for the uplink control channel may further include a normalizing operation in 250. In the normalizing operation in 250, the signal detector for the uplink control channel normalizes the signal of the subcarrier, the phase component of which is removed in the integrating operation in 240. The description of the normalizing operation is identical to the above description, and thus will be omitted.

Meanwhile, in accordance with an additional aspect of the present disclosure, the time error correction method of the signal detector for the uplink control channel may further include a signal selecting operation in 260. In the signal selecting operation in 260, the signal detector for the uplink control channel selects a signal having a maximum value among signals normalized in the normalizing operation in 250. The description of the signal selecting operation is identical to the above description, and thus will be omitted.

Meanwhile, in accordance with an additional aspect of the present disclosure, the time error correction method of the signal detector for the uplink control channel may further include a sequence generating operation in 208. In the sequence generating operation in 208, the signal detector for the uplink control channel generates a possible number of sequences. The description of the sequence generating operation is identical to the above description, and thus will be omitted.

Meanwhile, in accordance with an additional aspect of the present disclosure, the time error correction method of the signal detector for the uplink control channel may further include a signal receiving operation in 202, a guard interval removing operation in 204, and an FFT operation in 206.

In the signal receiving operation in 202, the signal detector for the uplink control channel receives an uplink control channel time domain signal transmitted from a user terminal. The description of the signal receiving operation is identical to the above description, and thus will be omitted.

In the guard interval operation in 204, the signal detector for the uplink control channel removes a guard interval from the received uplink control channel time domain signal. The description of the guard interval operation is identical to the above description, and thus will be omitted.

In the FFT operation in 206, the signal detector for the uplink control channel converts the uplink control channel time domain signal, the guard interval of which is removed, into a frequency domain signal. The description of the FFT operation is identical to the above description, and thus will be omitted.

According to the present disclosure, time errors, which occur during adjustment of a starting point of an FFT of an uplink control channel signal, are simply corrected by use of differential modulation, thereby improving the signal detection performance of an uplink control channel, and preventing the performance degradation.

The present invention can be implemented as computer readable codes in a computer readable record medium. The computer readable record medium includes all types of record media in which computer readable data is stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A signal detector for an uplink control channel, the signal detector comprising:
a first multiplier configured to multiply a signal subjected to a fast Fourier transform (FFT) by a possible number of sequences;
a phase shifter configured to shift a phase of a signal output from the first multiplier;
a second multiplier configured to multiply a signal, which is directly output from the first multiplier and not phase-shifted, by a conjugate signal of the signal whose phase was shifted by the phase shifter; and
an integrator configured to integrate a signal being output from the second multiplier to remove a phase component of a subcarrier of the signal.

2. The signal detector of claim 1, further comprising:
a normalizer configured to normalize the signal of the subcarrier, the phase component of which is removed, output from the integrator.

3. The signal detector of claim 2, further comprising:
a signal selector configured to select a signal having a maximum value among normalized signals output from the normalizer.

4. The signal detector of claim 1, further comprising:
a sequence generator configured to generate a possible number of sequences.

5. The signal detector of claim 1, further comprising:
an FFT unit configured to convert a received uplink control channel time domain signal into a frequency domain signal.

6. The signal detector of claim 5, further comprising:
a guard interval remover configured to remove a guard interval from the received uplink control channel time domain signal.

7. The signal detector of claim 6, further comprising:
an RF processor configured to receive an uplink control channel time domain signal transmitted from a user terminal.

8. A time error correction method of a signal detector for an uplink control channel, the time error correction method comprising:
first multiplying a signal subjected to a fast Fourier transform (FFT) by a possible number of sequences;
shifting a phase of the signal multiplied in the first multiplying;
second multiplying the signal, which is multiplied in the first multiplying operation but not phase-shifted, by a conjugate signal of the signal whose phase is shifted in the shifting; and
integrating the signal multiplied in the second multiplying to remove a phase component of a subcarrier of the signal.

9. The time error correction method of claim 8, further comprising:
normalizing the signal of which the subcarrier has the phase component removed in the integrating.

10. The time error correction method of claim 9, further comprising:
selecting a signal having a maximum value among signals obtained from the normalizing.

11. The time error correction method of claim 8, further comprising:
generating a possible number of sequences.

12. The time error correction method of claim 8, further comprising:
receiving an uplink control channel time domain signal transmitted from a user terminal;
removing a guard interval from the received uplink control channel time domain signal; and
converting the uplink control channel time domain signal, the guard interval of which is removed, into a frequency domain signal.
